(19) United States
(12) Patent Application Publication
(10) Pub. No.: US 2014/0017347 A1
(43) Pub. Date: Jan. 16, 2014

(54) Insect killing method and composition

(71) Applicant: Rodney Christopher Williams, Houston, TX (US)

(72) Inventor: Rodney Christopher Williams, Houston, TX (US)

(21) Appl. No.: 13/065,401

(22) Filed: Mar. 15, 2011

(51) Int. Cl. A01N 65/44; A01P 15/00

(52) U.S. Cl. 424/750

(57) ABSTRACT

An insect killing method and composition includes a plurality of ingredients including instant white rice, distilled white vinegar, apple cider vinegar, powdered cane sugar, and water. The instant white rice, distilled white vinegar, apple cider vinegar, powdered cane sugar, and water are mixed together to define a mixture which is tumble-dried and used as pellets or powder. The mixture is poured or sprinkled on and around the perimeter of the nest of insects.

### BACKGROUND OF THE INVENTION

### Field of the Invention

The present invention relates to insect killing mixtures and more particularly pertains to a new insect killing mixture for positioning on and surrounding an insect nest and which is eaten by the insects and taken back to the nest to kill the queen(s) and or colony.

### SUMMARY OF THE INVENTION

The present invention meets the needs presented above by generally providing a plurality of ingredients including instant white rice, distilled white vinegar, apple cider vinegar, powdered cane sugar and water. The sweetener should be powdered cane sugar for a more even mix. It has been discovered that insects in particular the ant will not be attracted to bait that is too sweet. The instant white rice should be allowed to soak in the wet mixture then heated and tumbled dry to remove moisture, reduce weight and prevent sticking. The substance can be used as pellets or powder. Green food coloring is added to the vinegars and water to change the appearance of the rice. Instant white rice must be used because it works faster and more consistently because it is pre-cooked. Unlike many insect control compositions, this one works wet or dry. The shelf-life is infinite even after it has been opened. No poisons are used. Insects cannot develop immunity to it because it causes dehydration. The mixture should be poured or sprinkled on and around the perimeter of the insect nest.

There has thus been outlined, rather broadly, the more important features of the invention in order that the detailed description thereof that follows may be better understood and in order that the present contribution to the art may be better appreciated. There are additional features of the invention that will be described hereinafter and which will form the subject matter of the claims appended hereto.

The objects of the invention, along with the various features of novelty, that characterizes the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an ingredient list of an insect killing method and composition according to the present invention.

FIG. 2 is an in-use view of the present invention.

### DESCRIPTION OF THE PREFERRED EMBODIMENT

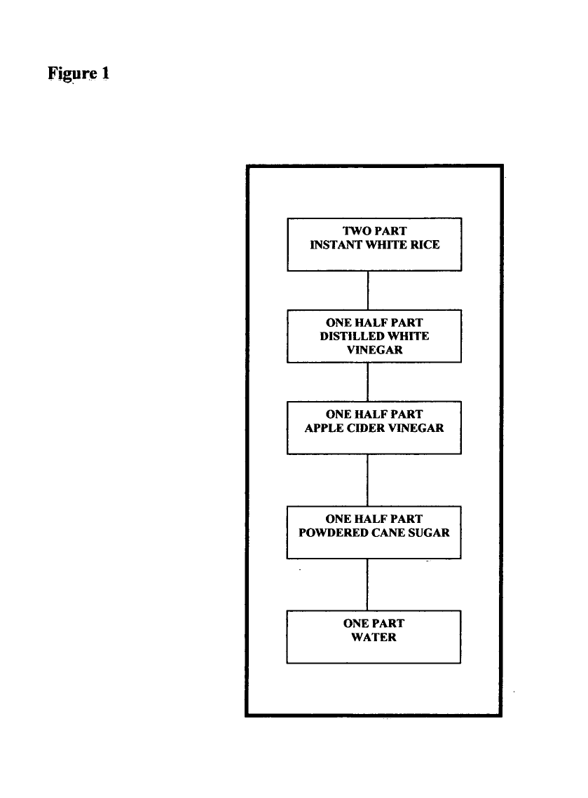

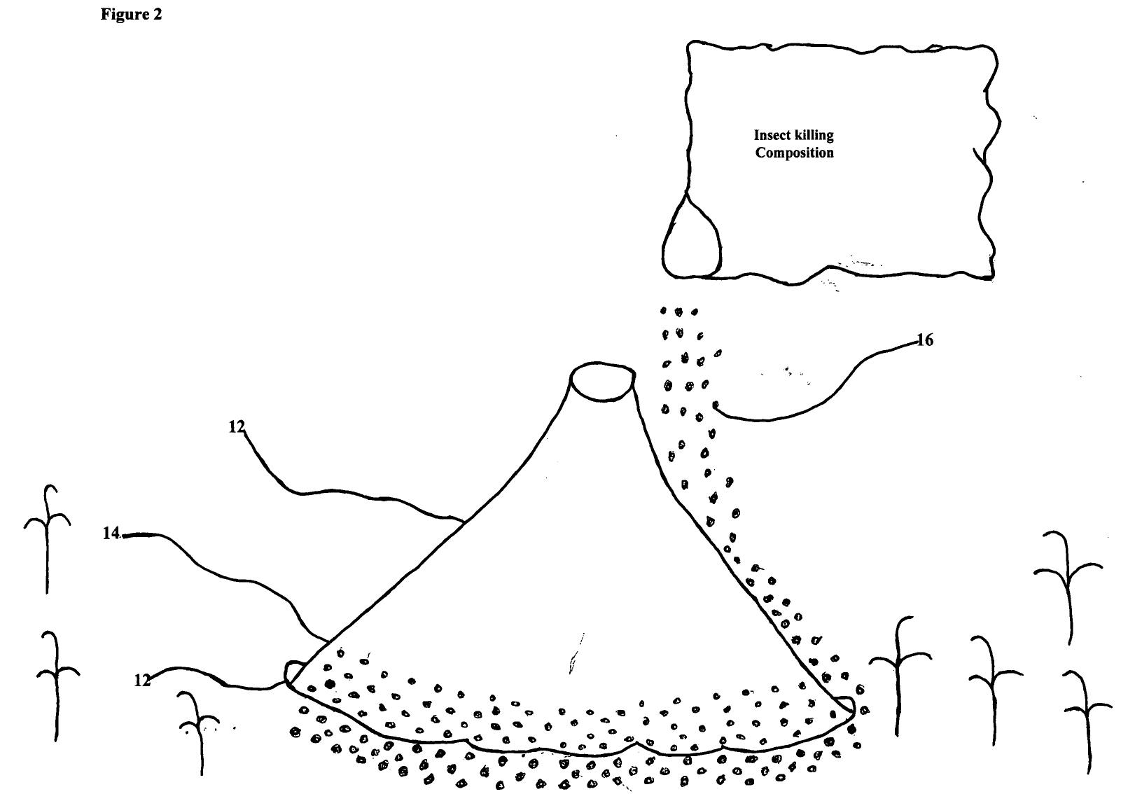

With reference now to the drawings, and in particular to FIGS. 1 through 2 thereof, a new insect killing mixture embodying the principles and concepts of the present invention and generally designated by the reference numeral 10 will be described. As best illustrated in FIGS. 1 through 2, the insect killing mixture include by volume one-half part distilled white vinegar, one half part apple cider vinegar, one part water with green food coloring and one half part powdered cane sugar.

The instant white rice the distilled white vinegar, apple cider vinegar, powdered cane sugar and water combined to define a mixture. This mixture is allowed to soak in all wet ingredients. This mixture is now heated and tumble dried. Once dry the mixture can be used as rice pellets or it can be powdered. This may be done by placing the mixture in a blender and blending until it forms a powder.

The mixture 16 is sprinkled or poured around a nest of insects 12 and in particular an ant mound 14. The mixture 16 is carried off by insects, which digest the mixture, as they are attracted to the sugar. The combination of the vinegars causes a delayed death and is virtually no threat to humans or animals. Unlike most insect control substances, it will not be weakened by moisture nor rain.

With respect to the above description then, it is to be realized that the optimum dimensional relationships for the parts of the invention, to include variations in size, materials, shape, form, function, and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be sorted to, falling within the scope of the invention.

I claim:

1. A method of killing insects, said method comprising the steps of:
providing a plurality of ingredients including instant white rice, distilled white vinegar, apple cider vinegar, powdered cane sugar, and water;
mixing together said instant white rice, said distilled white vinegar, said apple cider vinegar, said powdered cane sugar, and said water to define mixture;
tumble drying said mixture and the mixture can be used as pellets or powder,
pouring or sprinkling said mixture on and around the perimeter of the nest of insects.

2. The method according to claim 1, wherein the step of providing said ingredients includes providing by volume two parts of said instant white rice, one-half part of said distilled white vinegar, one-half part said apple cider vinegar, one-half part of said powdered cane sugar, and one part said water.

3. A method of killing insects, said method comprising the steps of:
providing a plurality of ingredients including by volume two parts of said instant white rice, one half part of said distilled white vinegar, one half part of said apple cider vinegar, one half part of said powdered cane sugar, and one part of said water, mixing together said instant white rice, said distilled white vinegar, said apple cider vinegar, said powdered cane sugar, and water to define a mixture; tumble-drying said mixture and mixture can be used as pellets or powder, pouring or sprinkling mixture an around the perimeter of the nest of insects.

4. (canceled)

5. (canceled)

6. (canceled)
